(19) United States
(12) Patent Application Publication
(10) Pub. No.: US 2006/0214629 A1
(43) Pub. Date: Sep. 28, 2006

(54) Locating recess for batteries

(76) Inventors: Chung-Hung Tsai, Taipei (TW); Chih-Pu Tsai, Taipei (TW)

Correspondence Address: BRUCE H. TROXELL, SUITE 1404, 5205 LEESBURG PIKE, FALLS CHURCH, VA, 22041, US

(21) Appl. No.: 11/117,363

(22) Filed: Apr. 29, 2005

(30) Foreign Application Priority Data
Mar. 23, 2005 (TW) 094108966

(51) Int. Cl. H02J 7/00

(52) U.S. Cl. 320/112

(57) ABSTRACT

A locating recess for batteries is disposed at a portable power driven article and provides a size and shape corresponding the batteries. An open end is disposed at two opposite lateral sides thereof for the batteries being moved in and out. A power source terminal is provided for being able to electrically contact with an output end of at least one of the batteries.

### FIELD OF THE INVENTION

The present invention relates to a locating recess for batteries, and, particularly to a locating recess for batteries in a mobile phone, PDA, laptop computers, iPod, a portable medical-appliance, a digital camera or a remote controller.

### BACKGROUND OF THE INVENTION

Due to electronic technology developing and changing rapidly, the wireless technique is widely used to make human life more convenient. This is the reason why the mobile phone, PDA, laptop computers, iPOD, digital camera and the remote controller and even the portable medical appliance are getting so close to our lives.

In fact, the preceding portable articles need batteries especially rechargeable batteries. In order to avoid power supply problem at places inconvenient for taking electricity, spare batteries are usually equipped for urgent need. Currently, universal batteries can be divided into cylindrical batteries and plate batteries.

Taking the mobile phone as an example, in the case of power in the battery being insufficient, the mobile phone with the battery can be inserted to a charger for recharging. If it is incapable of conducting the recharging job, mostly the battery is replaced by a spare battery. The mobile phone has to be turned off first, then the battery being taken out, and then the spare battery is filled in instead. Next, the mobile phone needs to be turned back on and then the password or PIN needs to be keyed in (including PIN card or SIM card) and then the mobile phone start searching for signal to get connected. The entire procedure can be very tedious.

For products such as PDA and laptop computers, the work status needs to also be considered during replacing battery because the information at work is very possible to loss while the power source is exhausted.

### SUMMARY OF THE INVENTION

An object of the present invention is to provide a locating recess for batteries in a product with battery with which a structure is designed to correspond to the battery and allow the battery moving along a specific track for being replaced with a new one under a condition of the power source being kept supplying.

Taking the mobile phone as an example, once the battery in the product needs to be replaced, simply move the battery to a certain position and the spare battery is inserted to and pushed along the track. Then, the circuit is switched to the new battery and the original battery is removed completely. It is noted that it is not necessary to turn off and turn on the product during the replacement of the battery.

Hence, the characteristics of the present invention is in that the battery is capable of moving along a single moving path and the power supply is continuous without being disconnected at the time of replacing the battery.

### BRIEF DESCRIPTION OF THE DRAWINGS

The present invention can be more fully understood by reference to the following description and accompanying drawings, in which:

FIG. 1 is a perspective view of a locating recess for batteries according to the present invention;

FIG. 2 is a perspective view illustrating an old battery being removed from the locating recess of the present invention;

FIG. 3 is a perspective view illustrating a new battery being slid into the locating recess of the present invention;

FIG. 4 is a perspective view illustrating the new battery being in place of the old battery completely;

FIG. 5 is a plan view illustrating the old battery being in a state of electrical connection while in the locating recess of the present invention;

FIG. 6 is a plan view illustrating the old battery being in a state of electrical connection while it is moving out of the locating recess of the present invention;

FIG. 7 is a plan view illustrating the old battery and the new battery being in a state of electrical connection while the new battery is moving into the locating recess of the present invention;

FIG. 8 is a plan view illustrating the old battery having been removed and the new battery having been located at the locating recess of the present invention;

FIG. 9 is a plan view illustrating the locating recess providing a locating part;

FIG. 10 is perspective view illustrating the locating recess of the present invention being associated with a hole; and

FIG. 11 is a plan view illustrating the locating recess used for multiple batteries.

### DETAILED DESCRIPTION OF THE INVENTION

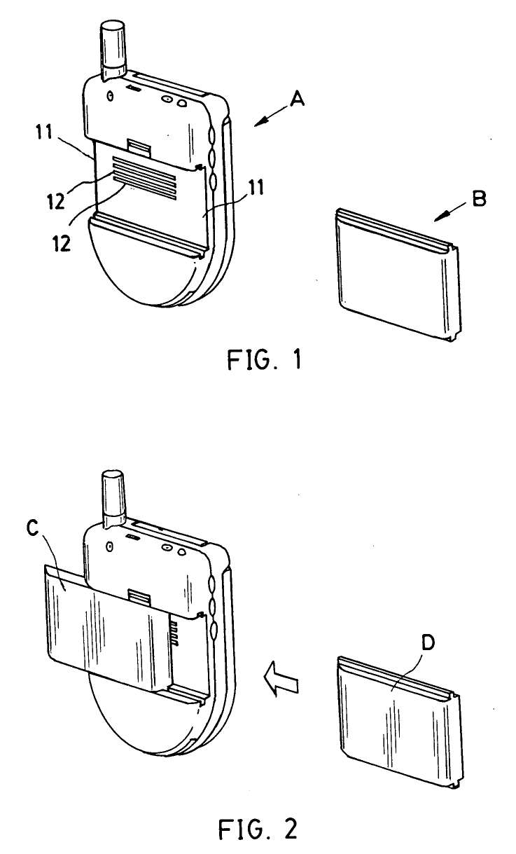

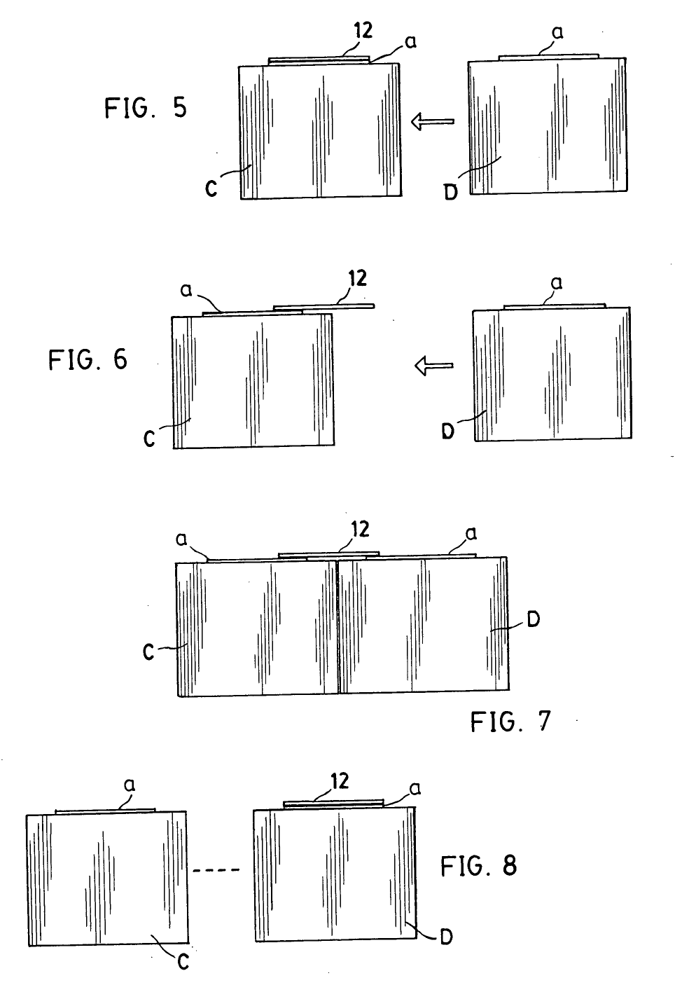

Referring to FIGS. 1 to 4, a mobile phone A is taken as an example with the locating recess for batteries according to the present invention. Basically, a battery B is attached to the back of the mobile phone due to the operational panel being arranged at the front side thereof. The locating recess has an opening 11 at both ends of the locating recess and has a power source terminal 12 therein for electrically connecting with the battery B. For the mobile phone A, a grounding terminal and a power indicating terminal can be added to the locating recess 1. The power source terminal 12 corresponds to the output end “a” (shown in FIG. 5) of the battery B so as to couple with the output end “a”. Further, the power source terminal 12 is connected to the mobile phone A via an electrical circuit for supplying power to the mobile phone A. These are prior art and no detail will be described further.

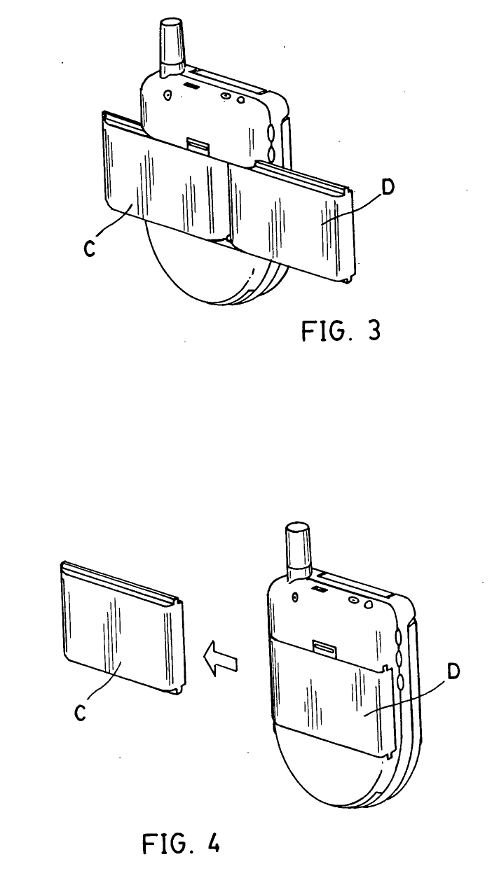

In order to allow the power source terminal 12 performing power supply during the old battery C being replaced by the new battery D, the power source terminal 12 has a length corresponding to the location and length of the output end a of the battery B. That is, the output end of the new battery D is capable of touching the power source terminal 12 before the old battery C being apart from the power source terminal 12 completely; while the new battery D enters the locating recess of the present invention and pushes the old battery outward as shown in FIG. 3. In this way, an effect of keeping the mobile phone in a state of keeping the power on can be obtained in spite of the old battery C being in the process of being replaced by the new battery D. FIG. 4 shows the new battery D has replaced the old battery C and the old battery C can be recharged afterward.

Referring to FIGS. 5 to 8, the power source terminal 12 is disposed at the upper wall of the locating recess of the present invention and the output end “a” of the old battery C is disposed at the top thereof to contact with the power source terminal 12 for power supply. Then, the old battery C is moved leftward as shown in FIG. 6. FIG. 7 shows the new battery D is placed in the locating recess of the present invention and moves along with the old battery C such that both the batteries C, D are in a state of contacting the power source terminal 12 simultaneously. Next, the new battery D moves continuously till being located at the locating recess of the present invention instead of the old battery C as shown in FIG. 8. It is worth to mention that the power of the mobile phone A is kept continuously maintained during the process of the battery replacement.

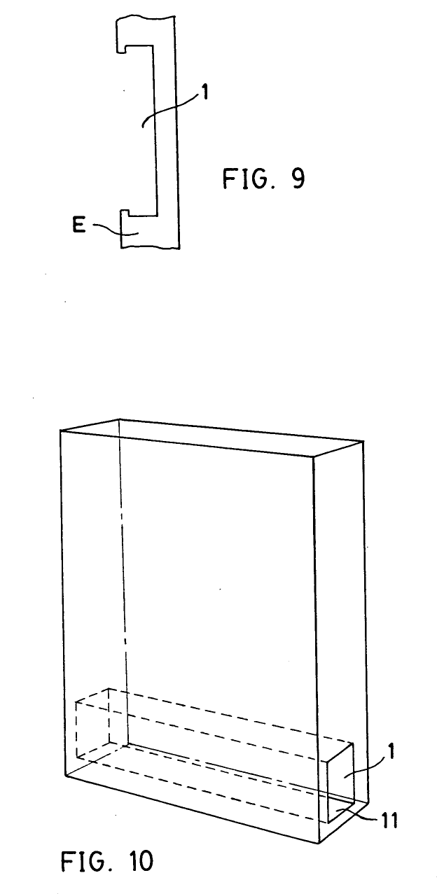

In order to enhance the battery B moving under better regulation, a regulating part E such as an extruding projection, is provided at the casing of the mobile phone A to form the locating recess 1 as shown in FIG. 9 and the power source terminal 12 can be disposed at the top, the bottom or the lateral side for electrical connection.

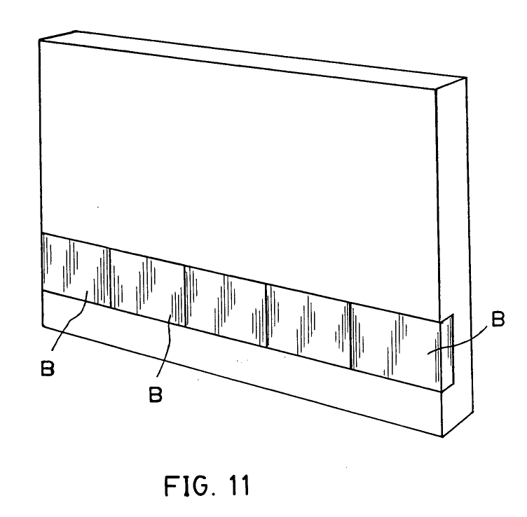

FIG. 10 shows the locating recess 1 is an elongated uniform hole with two open ends and the power source terminal 12 can be located at one of the inner walls or an additional recess-projection device. The output end of the battery B can be provided corresponding to the power source terminal 12 for the battery replacement without electrical disconnection.

FIG. 11 shows a locating recess 1 is suitable for multiple batteries moving along with each other to perform the old batteries replacement with the power kept continuously maintained.

It is appreciated that the locating recess according to the present invention provides a function of the battery or batteries in a portable article or device being replaced under a condition of power keeping continuously maintained. It is advantageous that the portable article or device is capable of running continuously during the battery or batteries inside being replaced.

While the invention has been described with reference to a preferred embodiment thereof, it is to be understood that modifications or variations may be easily made without departing from the spirit of this invention, which is defined by the appended claims.

What is claimed is:

1. A locating recess for batteries disposed at a portable power driven article and provides a size and shape corresponding the batteries, said locating recess having an open end disposed at two opposite lateral sides for battery being moved in and out; and a power source terminal for being able to contact electrically with at least an output end of one of the batteries during part of each battery been located in said locating recess.

2. The locating recess as defined in claim 1, wherein the power source terminal is horizontally disposed.

3. The locating recess as defined in claim 1, wherein the power source terminal is vertically disposed.

4. The locating recess as defined in claim 1, wherein the power source terminal provides a length corresponding to the locating recess.

5. The locating recess as defined in claim 1, wherein two sets of power source terminals are provided.

6. The locating recess as defined in claim 1, wherein a regulation part is provided.

7. The locating recess as defined in claim 1, wherein the outer side thereof is closed.

8. The locating recess as defined in claim 1, wherein the power source terminal is arranged with other terminals.

9. The locating recess as defined in claim 1, wherein multiple pieces thereof are provided.

10. The locating recess as defined in claim 1 can be provided in a mobile phone, a laptop computer, an iPod, a portable medical appliance, a digital camera or a remote controller.
